(19) United States
(12) Patent Application Publication
(10) Pub. No.: US 2026/0161539 A1
(43) Pub. Date: Jun. 11, 2026

(54) SYSTEM FOR ARTIFICIAL INTELLIGENCE ACCELERATION, MEMORY DEVICE AND METHOD FOR OPERATING THE SAME

(71) Applicant: TAIWAN SEMICONDUCTOR MANUFACTURING COMPANY, LTD., Hsinchu (TW)

(72) Inventors: Win-San KHWA, Taipei City (TW); Ashwin Sanjay LELE, San Jose, CA (US); Bo ZHANG, San Jose, CA (US); Meng-Fan CHANG, Taichung City (TW)

(73) Assignee: TAIWAN SEMICONDUCTOR MANUFACTURING COMPANY, LTD., Hsinchu (TW)

(21) Appl. No.: 18/972,531

(22) Filed: Dec. 6, 2024

(51) Int. Cl. G06F 12/02; G06F 13/40

(52) U.S. Cl. CPC G06F 12/0207; G06F 13/4068

(57) ABSTRACT

A system for artificial intelligence acceleration is provided. The system includes a control circuit and a memory circuit coupled to the control circuit. The memory circuit includes a first local memory and a computing circuit. The first local memory stores weights and inputs of a machine learning model. The computing circuit includes input registers and local computing cells. The input registers are coupled together as a ring bus. Each of the input registers selects between first data from the first local memory and second data from an adjacent input register in the ring bus according to a first control signal from the control circuit. Each of the input registers stores the selected one of the first and second data. The local computing cells perform computations between data stored in the input registers and the weights.

### BACKGROUND

A machine learning model like neural network includes multiple layers of nodes for computation, which typically involve a great number of data elements. Accordingly, the transfer of data elements of the machine learning model is usually a bottleneck for artificial intelligence (AI) computation. In this regard, AI accelerators are proposed to provide improved data flow. For example, compute-in-memory (CIM) or near memory computing (NMC) device have been proposed to suppress the latency for data access to a memory, which help improve execution speed and reduces energy consumption of the machine learning.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system in accordance with various embodiments of the present disclosure.

FIG. 2 is a schematic diagram of a memory circuit which is an example of the memory circuit of FIG. 1, in accordance with various embodiments of the present disclosure.

FIG. 3 is a schematic diagram of a memory circuit configured with respect to the memory circuit of FIG. 2 and the memory circuit of FIG. 1, in accordance with various embodiments of the present disclosure.

FIGS. 4-5 are schematic diagrams of examples of the bit cell in the memory circuits of FIGS. 1-3, in accordance with various embodiments of the present disclosure.

FIG. 6 is a schematic diagram of an example of the latch in the memory circuits of FIGS. 1-5, in accordance with various embodiments of the present disclosure.

FIGS. 7-8 are schematic diagrams of examples of the local computing cell in the memory circuits of FIGS. 1-3, in accordance with various embodiments of the present disclosure.

FIG. 9 is a schematic diagram of an example of the adder tree and the accumulator in the memory circuits of FIGS. 1-8, in accordance with various embodiments of the present disclosure.

FIG. 10 is a schematic diagram of an example of input registers, which are the input registers in the memory circuits of FIGS. 1-9, in accordance with various embodiments of the present disclosure.

FIG. 11 is a schematic diagram of the computing circuit 310 of the memory circuits of FIGS. 1-10, in accordance with various embodiments of the present disclosure.

FIGS. 12-19 depict an example of operation of a memory circuit configured with respect to the memory circuits of FIGS. 1-11, in accordance with various embodiments of the present disclosure.

FIGS. 20-22 depict an example of operation of a memory circuit configured with respect to the memory circuits of FIGS. 1-19, in accordance with various embodiments of the present disclosure.

FIG. 23 is a flowchart diagram of a method for operating the system, the control circuits in FIGS. 1-22, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

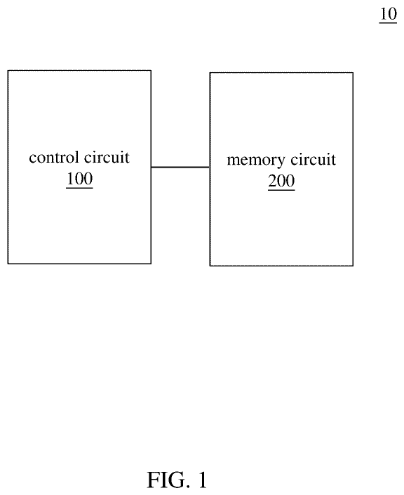

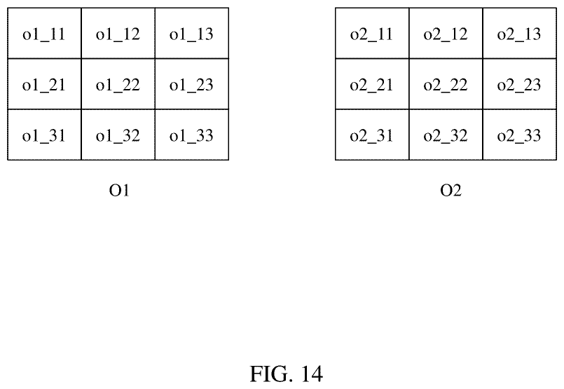

This application relates to a system of artificial intelligence (AI) accelerator with improved data bus design which supports custom dataflow to enhance computation performance. In some approaches, the dataflow for machine learning model computation is in an input-stationary manner or a weight-stationary manner. However, either of the input-stationary manner and the weight-stationary manner faces the problem of inefficiency in memory accessing. To solve the problem, the system of this application supports interleaving input-stationary and weight-stationary (IS-WS) dataflow. The interleaving IS-WS dataflow is enabled by designs of an input register ring bus and partial data bus disabling. Further details are described in the following paragraphs with reference to FIGS. 1-23.

Reference is now made to FIG. 1. FIG. 1 is a schematic diagram of a system 10 in accordance with various embodiments of the present disclosure. In some embodiments, the system 10 is an AI accelerator system. The system 10 includes a control circuit 100 and a memory circuit 200. The control circuit 100 is coupled to the memory circuit 200. In operation, the control circuit 100 outputs instructions to memory circuit 200 and the memory circuit 200 operates according to the instructions. In some embodiments, the memory circuit 200 performs machine learning model (e.g., neural network model) computations according to the instructions from the control circuit 100. In some embodiments, the memory circuit 200 is a compute-in-memory (CIM) circuit or a near-memory-computing (NMC) circuit.

According to various embodiments, the control circuit 100 may be a central processing unit (CPU), or other general-purpose or special-purpose processor, a microprocessor, a digital signal processor (DSP), a programmable controller, an application-specific integrated circuit (ASIC), an arithmetic logic unit (ALU), a complex programmable logic device (CPLD), a field-programmable gate array (FPGA), or other similar components or a combination of the above components.

In some embodiments, the control circuit 100 includes a buffer storing the instructions for the memory circuit 200.

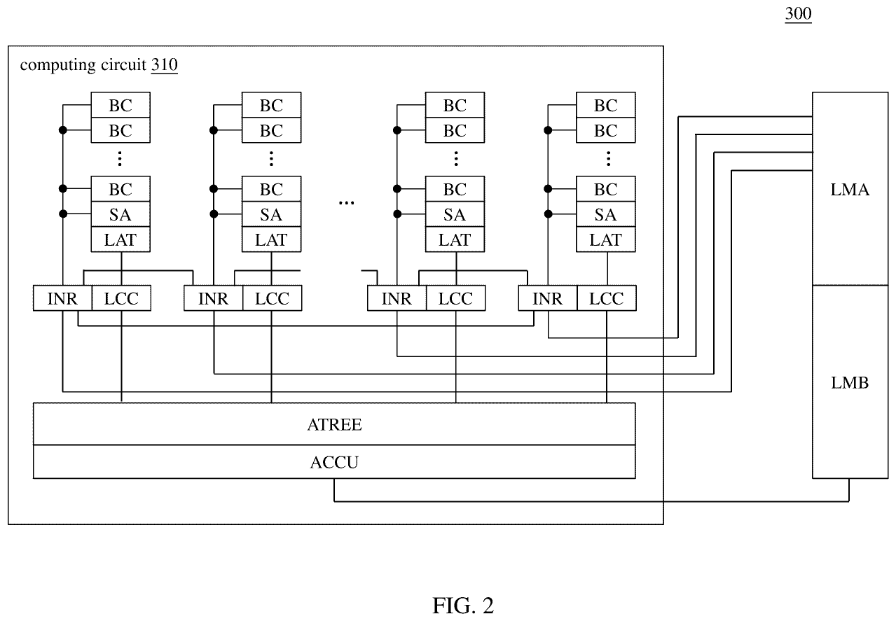

Reference is now made to FIG. 2. FIG. 2 is a schematic diagram of a memory circuit 300 which is an example of the memory circuit 200 of FIG. 1, in accordance with various embodiments of the present disclosure.

As shown in FIG. 2, the memory circuit 300 includes a local memory LMA, a local memory LMB and a computing circuit 310. The computing circuit 310 is coupled to the local memory LMA and the local memory LMB.

The local memory LMA and the local memory LMB may be storage devices like flip-flops, random access memory, etc. In operation, the local memory LMA stores weights of a machine learning model and inputs (e.g., feature maps) of the machine learning model. In some embodiments, the weights and inputs are weights and inputs of a layer of the machine learning model. The computing circuit 310 performs computations of between the weights and the inputs to generate outputs of the machine learning model. Then, the local memory LMB stores the outputs.

For practical applications, the machine learning model may be utilized in various fields such as machine vision, image classification, or data classification. For example, the outputs may be used for classifying medical images. For example, they can be used to classify X-ray images in normal conditions, with pneumonia, with bronchitis, or with heart disease. The outputs may also be used to classify ultrasound images with normal fetuses or abnormal fetal positions. On the other hand, the machine learning model can also be used to classify images collected in automatic driving, such as distinguishing normal roads, roads with obstacles, and road conditions images of other vehicles. Furthermore, the machine learning model can be utilized in other similar fields, such like music spectrum recognition, spectral recognition, big data analysis, data feature recognition and other related machine learning fields.

In some embodiments, the computing circuit 310 includes multiple bit cells BC, multiple sense amplifiers SA, multiple latches LAT, multiple input registers INR, multiple local computing cells LCC, an adder tree ATREE and an accumulator ACCU.

For illustration, the local memory LMA is coupled to the input registers INR. The local memory LMB is coupled to the accumulator ACCU. The accumulator ACCU is coupled to the adder tree ATREE. The adder tree ATREE is coupled to the local computing cells LCC.

In some embodiments, the bit cells BC are arranged in rows and columns. Each column of the bit cells are coupled to a sense amplifier SA of the column. The sense amplifier SA of the column is coupled to a latch LAT of the column. The latch LAT of the column is coupled to a local computing cell LCC of the column.

The local computing cell LCC of the column is coupled to an input register INR of the column. The input register INR of the column is further coupled to the latch LAT of the column and each bit cell BC of the column.

The local computing cell LCC performs computations between data in the latch LAT and the input register INR. The adder tree ATREE sums up computation results of the local computing cells LCC. The accumulator ACCU accumulates the sum from the adder tree ATREE and generates the output of the machine learning model to store in the local memory LMB.

As shown in FIG. 2, the input registers INR are coupled one after another to form an input register ring bus. Specifically, the input register INR in each column is coupled to the input registers INR in adjacent columns, and the input register INR in the first column (leftmost column) is coupled to the input register INR in the last column (rightmost column).

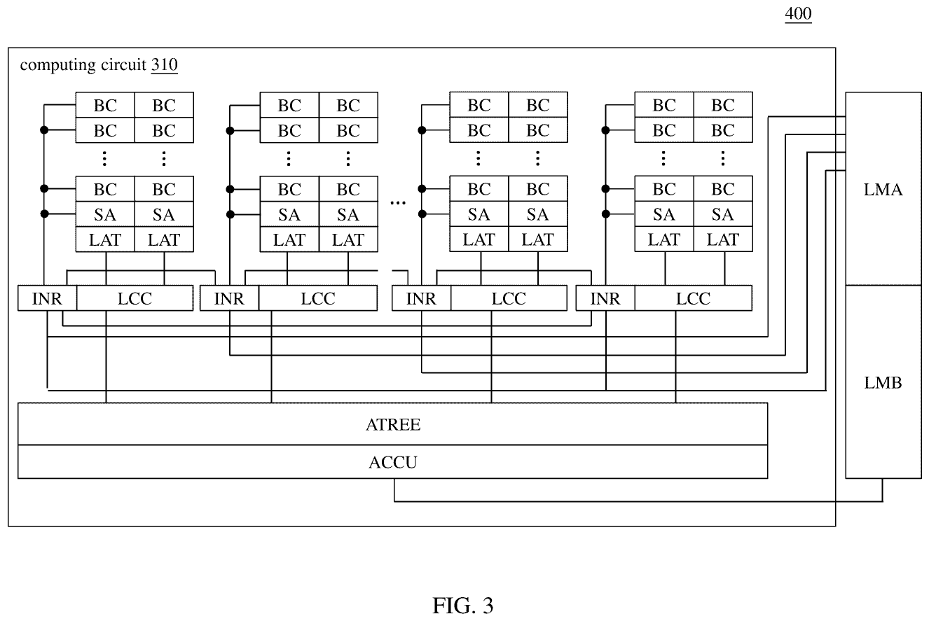

Reference is now made to FIG. 3. FIG. 3 is a schematic diagram of a memory circuit 400 configured with respect to the memory circuit 300 of FIG. 2 and the memory circuit 200 of FIG. 1, in accordance with various embodiments of the present disclosure. With respect to the embodiments of FIG. 2, like elements in FIG. 3 are designated with the same reference numbers for ease of understanding. The specific operations of similar elements, which are already discussed in detail in above paragraphs, are omitted herein for the sake of brevity.

The difference between the memory circuit 300 and the memory circuit 400 is that each local computing cell LCC of the memory circuit 400 corresponds to two adjacent columns instead of one column. Specifically, latches LAT of two adjacent columns are coupled to a corresponding local computing cell LCC. The bit cells BC and the latches LAT of the two columns are coupled to a corresponding input register INR that is coupled to the corresponding local computing cell LCC. The local computing cell LCC performs computations between data in the corresponding two latches LAT and the input register INR.

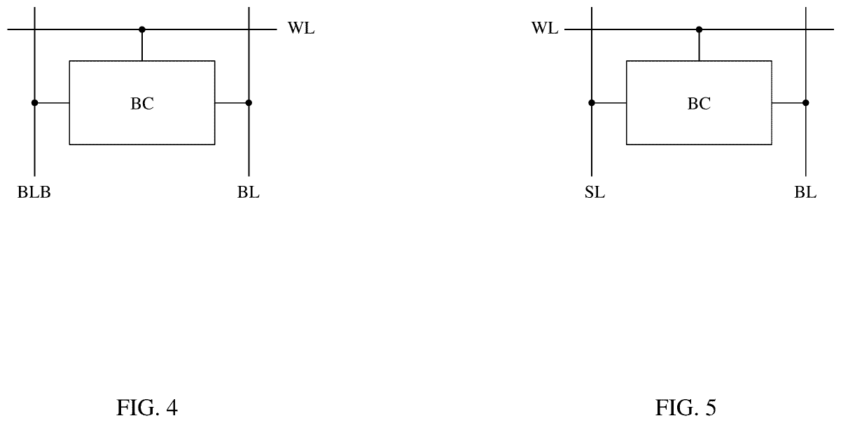

Further details about the bit cell BC, the latch LAT, the local computing cell LCC, the adder tree ATREE, the accumulator ACCU and the input register INR are described in the following paragraphs with reference to FIGS. 4-11.

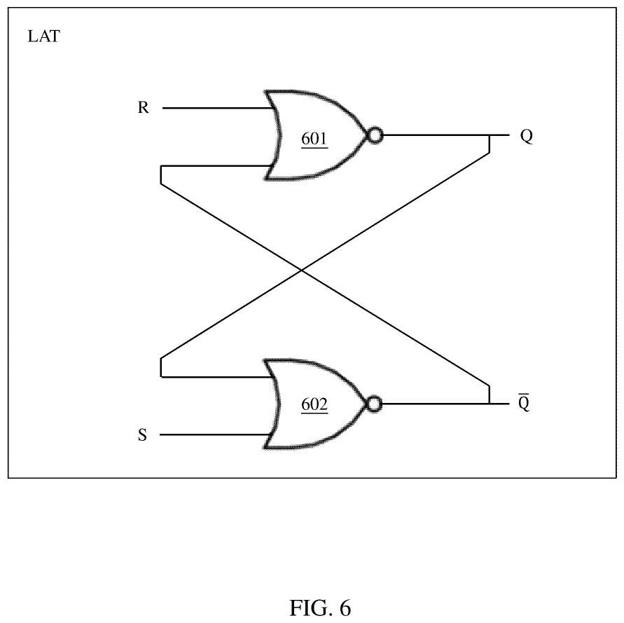

Reference is now made to FIGS. 4-5. FIGS. 4-5 are schematic diagrams of examples of the bit cell BC in the memory circuits 200, 300 and 400 of FIGS. 1-3, in accordance with various embodiments of the present disclosure. With respect to the embodiments of FIGS. 1-3, like elements in FIGS. 4-5 are designated with the same reference numbers for ease of understanding.

According to various embodiments, the bit cell BC may be any suitable memory cell, for example, a static random-access memory (SRAM) cell, a resistive random-access memory (ReRAM) cell, a gaincell, etc.

As shown in FIG. 4, in some embodiments, each bit cell BC is coupled to a word line WL, a bit line BL and a complementary bit line BLB. In some embodiments, the bit cells BC in the same column is coupled to the same bit line BL and the same complementary bit line BLB. The bit cells BC in the same row is coupled to the same word line WL.

In some embodiments, the input register INR is coupled to the sense amplifier SA and the bit cells BC of the corresponding column through the bit line BL. The bit line BL transmits data from the input register INR to the bit cells BC in the column and transmits data from the bit cells BC to the sense amplifier SA of the column.

The word line WL transmits a control signal to select a row of bit cells BC for accessing. For example, to select a bit cell BC in a column to write/read, the voltage of the word line WL coupled to the bit cell BC is pulled high or low. Specifically, in some embodiments, a gate transistor coupled to the word line WL in the bit cell BC is turned on for write/read operation, in response to the voltage of the word line WL pulled high or low.

As shown in FIG. 5, different from the bit cell BC shown in FIG. 4, in some embodiments, each bit cell BC is coupled to a source line SL instead of the complementary bit line BLB. In some embodiment, the source line SL is coupled to a ground voltage.

Reference is now made to FIG. 6. FIG. 6 is a schematic diagram of an example of the latch LAT in the memory circuits 200, 300 and 400 of FIGS. 1-5, in accordance with various embodiments of the present disclosure. In some embodiments, the latch LAT includes a SR latch that includes a NOR gate 601 and a NOR gate 602. In some embodiments, the sense amplifier SA read data from the bit cell BC. Then, the latch LAT receives data from the sense amplifier SA through the input terminals S and R of the latch LAT. The latch LAT stores the data at the output terminals Q and Q.

In some embodiments, the input terminal S is coupled to the bit line BL to receive the data read from the bit cell BC. The output terminal Q stores the data from the bit line BL. The output terminal Q stores the data inverted to the data from the bit line BL.

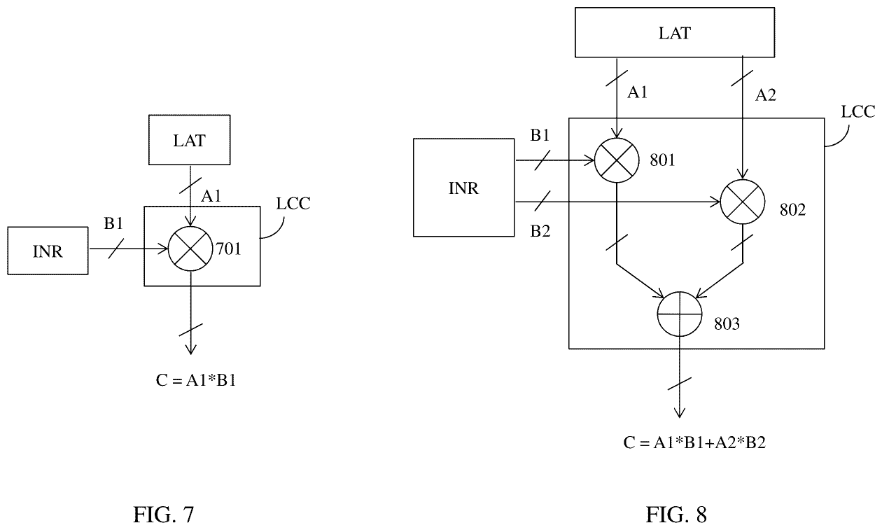

Reference is now made to FIGS. 7-8. FIGS. 7-8 are schematic diagrams of examples of the local computing cell LCC in the memory circuits 200, 300 and 400 of FIGS. 1-3, in accordance with various embodiments of the present disclosure. With respect to the embodiments of FIGS. 1-6, like elements in FIGS. 7-8 are designated with the same reference numbers for ease of understanding.

As shown in FIG. 7, in some embodiments, the local computing cell LCC includes a multiplier 701. The multiplier 701 receives data A1 from the latch LAT and receives data B1 from the input register INR. The multiplier 701 performs the multiplication between the data A1 and B1 and generates an output C=A1*B1.

In some embodiments, the latch LAT and the input register INR store multiple bits of data. The multiplier 701 is a multi-bit multiplier that performs multi-bit multiplication between bits of the data A1 and B1.

As shown in FIG. 8, in various embodiments, the local computing cell LCC is coupled to multiple latches LAT and performs computation of data from the latches LAT and data from the input register INR.

In some embodiments, the local computing cell LCC performs product-sum between a pair of data A1-A2 and B1-B2 stored in the latch LAT and the input register INR.

For illustration, the local computing cell LCC includes a multiplier 801, a multiplier 802 and an adder 803. The multiplier 801 receives data A1 from the latch LAT and receives data B1 from the input register INR. The multiplier 802 receives data A2 from the latch LAT and receives data B2 from the input register INR. The multiplier 801 performs the multiplication between the data A1 and B1 and the multiplier 802 performs the multiplication between the data A2 and B2. The adder 803 performs the addition between the outputs of the multipliers 801-802 and generates an output C=A1*B1+A2*B2.

In some embodiments, the latch LAT and the input register INR store multiple bits of data. The multipliers 801-802 are multi-bit multipliers and the adder 803 is a multi-bit adder.

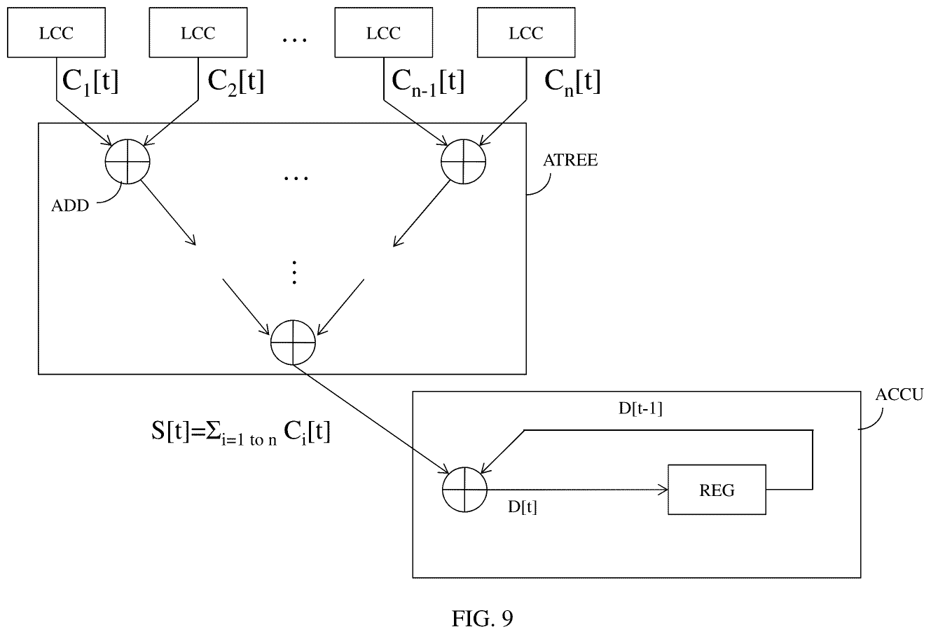

Reference is now made to FIG. 9. FIG. 9 is a schematic diagram of an example of the adder tree ATREE and the accumulator ACCU in the memory circuits 200, 300 and 400 of FIGS. 1-8, in accordance with various embodiments of the present disclosure. With respect to the embodiments of FIGS. 1-8, like elements in FIG. 9 are designated with the same reference numbers for ease of understanding.

As shown in FIG. 9, the adder tree ATREE includes a tree of adders ADD. The adder tree ATREE sums up the output of each local computing cell LCC coupled to the adder tree ATREE. For example, the adder tree ATREE sums the outputs C₁[t] to Cₙ[t] of the local computing cell LCC to generate the sum S[t]=Σᵢ₌₁ⁿ Cᵢ[t].

In some embodiments, every two local computing cells LCC are coupled to an adder ADD of a first layer of the adder tree ATREE for computing the addition between the outputs of the two local computing cells LCC. Every two adders ADD in the first layer are coupled to an adder ADD of a second layer of the adder tree ATREE for computing the addition between the outputs of the two adders ADD. The following layers of the adder tree ATREE are coupled in the similar manner to generate the sum S[t].

The accumulator ACCU accumulates the sums output from the adder tree ATREE. Specifically, the accumulator ACCU adds the current sum S[t] and the data D[t−1] stored in the accumulator ACCU. In some embodiments, the accumulator ACCU includes an adder ADD and a register REG. The adder ADD adds the data D[t−1] stored in the register REG and the sum S[t] from the adder tree ATREE and generate data D[t]. The register REG updates the stored data with the data D[t]. Specifically, the register REG stores the data D[t] to replace the data D[t−1].

In some embodiments, the computing circuit 310 performs a multiply-and-accumulate (MAC) operation of the inputs and weights of the machine learning model through multiple cycles. The accumulator ACCU generates a result of the MAC operation between one weight and one input as the output of the machine learning model after the cycles. Then, the local memory LMB stores the output of the machine learning model.

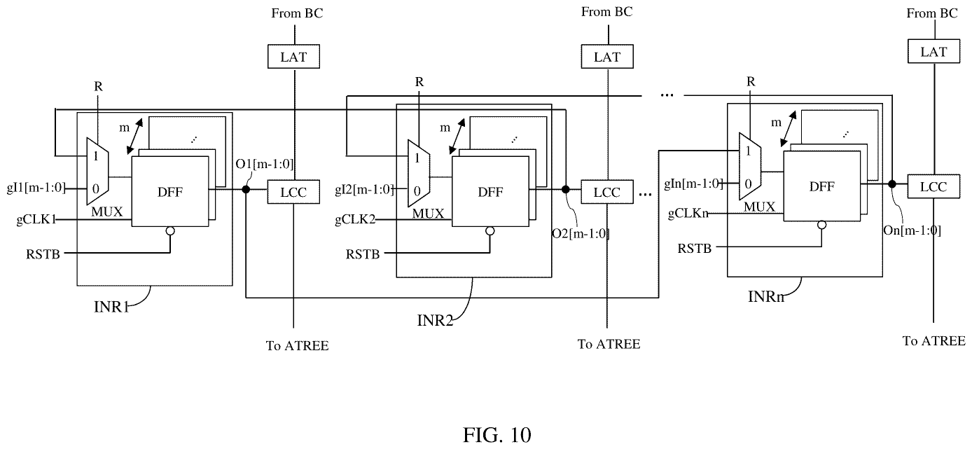

Reference is now made to FIG. 10. In accordance with various embodiments of the present disclosure, FIG. 10 is a schematic diagram of an example of input registers INR1-INRn, which are the input registers INR corresponding to a number n of columns in the memory circuits 200, 300 and 400 of FIGS. 1-9, in which n is a integer. With respect to the embodiments of FIGS. 1-9, like elements in FIG. 10 are designated with the same reference numbers for ease of understanding.

As shown in FIG. 10, each of the input registers INR1-INRn includes a multiplexer MUX and a number m of D flip-flops DFF, in which m is an integer. The D flip-flops DFF receive a clock signal (e.g., gCLK1) and a restart signal RSTB. The D flip-flops DFF receive m bits of data output from the multiplexer MUX. In response to the rising of the clock signal, the D flip-flops DFF stores the data from the multiplexer MUX as m bits of output (e.g., output O1[m−1:0]).

A first input terminal of the multiplexer MUX is coupled to the local memory LMA to receive m bits of input (e.g., gI1[m−1:0]) and a second input terminal of the multiplexer MUX is coupled to the output terminal of the D flip-flops DFF of an adjacent input register INR. For example, an input terminal of the multiplexer MUX of the input register INR1 is coupled to the output terminal of the D flip-flops DFF of the input register INR2.

The multiplexer MUX of the last (rightmost) input register INRn is coupled to the output terminal of the D flip-flops DFF of the first (leftmost) input register INR1. As a result, the input registers INR1-INRn are coupled together to form the input register ring bus.

According to a rotate signal R, the multiplexer MUX selects one of data of the first terminal and data from the second input terminal as the data output through the output terminal of the multiplexer MUX. For example, in response to the rotate signal R having a first logic value (e.g., logic one), the multiplexer MUX selects data from the adjacent input register INR as the output of the multiplexer MUX. On the contrary, in response to the rotate signal R having a second logic value (e.g., logic zero), the multiplexer MUX selects data from the local memory LMA as the output of the multiplexer MUX. In some embodiments, the control circuit 100 generates the rotate signal R.

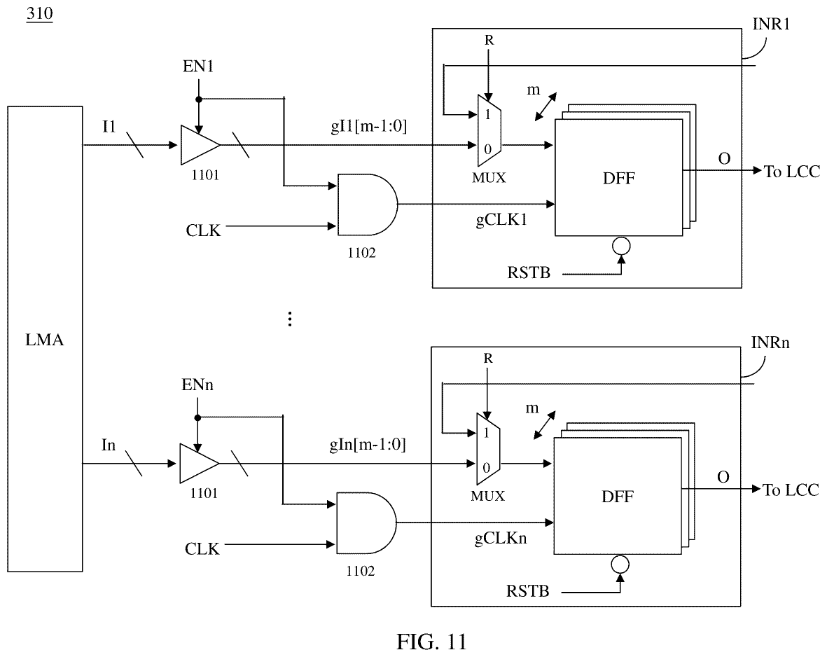

Reference is now made to FIG. 11. FIG. 11 is a schematic diagram of the computing circuit 310 of the memory circuits 200, 300 and 400 of FIGS. 1-10, in accordance with various embodiments of the present disclosure. With respect to the embodiments of FIGS. 1-10, like elements in FIG. 11 are designated with the same reference numbers for ease of understanding.

In some embodiments, the computing circuit 310 further includes multiple tri-state buffers 1101 and multiple AND gates 1102. For illustration, each input register INR is coupled to a corresponding tri-state buffer 1101 and a corresponding AND gate 1102.

As shown in FIG. 11, the input terminal of the tri-state buffer 1101 is couple to the local memory LMA. The output terminal of the tri-state buffer 1101 is couple to the first input terminal of the multiplexer MUX. The control terminal of the tri-state buffer 1101 receives an enable signal (e.g., EN1-ENn).

In some embodiments, the enable signals EN1-ENn are used to enable the input register INR1-INRn. For example, the enable signal EN1 is set to have a first logic value (e.g., logic one) to enable the input register INR1 to update the data stored in the input register INR1. The enable signal EN1 is set to have a second logic value (e.g., logic zero) to disable the input register INR1 from updating the data stored in the input register INR1. In some embodiments, the enable signals EN1-ENn are generated by the control circuit 100.

In some embodiments, the tri-state buffer 1101 receives m bits of data from the local memory LMA and generates m bits of input to the multiplexer MUX according to the the enable signal. For example, in response to the enable signal EN1 having the first logic value (e.g., logic one), the tri-state buffer 1101 passes the data I1 to the multiplexer MUX as the m bits of input gI1[m−1:0]. On the contrary, in response to the enable signal EN1 having the second logic value (e.g., logic zero), the tri-state buffer 1101 does not passes the data I1 to the multiplexer MUX. In other words, the output gI[m−1:0] is fixed when the enable signal EN having the second logic value.

A first input terminal of the AND gate 1102 is coupled to the enable signal (e.g., EN1). A second terminal of the AND gate 1102 is coupled to a clock signal CLK of the computing circuit 310. The AND gates 1102 generate the clock signal gCLK1-gCLKn to the clock terminal of the D flip-flops according to the enable signal EN1-ENn. For example, in response to the enable signal EN1 having the first logic value (e.g., logic one), the AND gate 1102 transmits the clock signal CLK as the clock signal gCLK1 to the D flip flip of the input register INR1. On the contrary, in response to the enable signal EN1 having the second logic value (e.g., logic zero), the tri-state buffer 1101 does not transmit clock signal CLK. In other words, the clock signal gCLK1 is fixed with a logic value (e.g., logic zero) when the enable signal EN1 having the second logic value.

The configurations of FIGS. 1-11 are given for illustrative purposes. Various implements are within the contemplated scope of the present disclosure. For example, in some embodiments, each latch LAT of FIG. 3 is coupled to more columns of bit cells BC (e.g., three columns). In some embodiments, the latch LAT of each column is included in the sense amplifier SA of the column. In some embodiments, the input register INR in FIG. 10 includes only one D flip-flop DFF. In some embodiment, the multiplier 801 in FIG. 8 is coupled to a first latch LAT and the multiplier 802 in FIG. 8 is coupled to a second latch LAT different from the first latch LAT to perform product-sum between data in the input register INR and data from different latches LAT. According to various embodiments, the local computing cell LCC is configured to perform any suitable computations between data in the input register INR and the latch LAT.

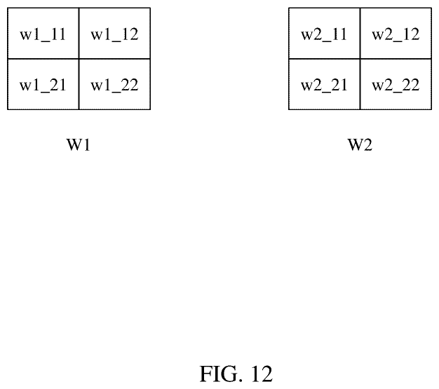

Reference is now made to FIGS. 12-19. FIGS. 12-19 depict an example of operation of a memory circuit 500 configured with respect to the memory circuits 200, 300, and 400 of FIGS. 1-11, in accordance with various embodiments of the present disclosure. With respect to the embodiments of FIGS. 1-11, like elements in FIGS. 12-19 are designated with the same reference numbers for ease of understanding.

The example of FIGS. 12-19 is a toy example of computations of a machine learning model performed by the system 10 and the memory circuit 500 of the system 10 is configured for the ease of explanation. In this example, as shown in FIGS. 12-14, the machine learning model of the system 10 has two 2×2 weights (i.e., kernels) W1 and W2, a 4×4 feature map F. The system 10 generates two 3×3 outputs O1 and O2 of the machine learning model.

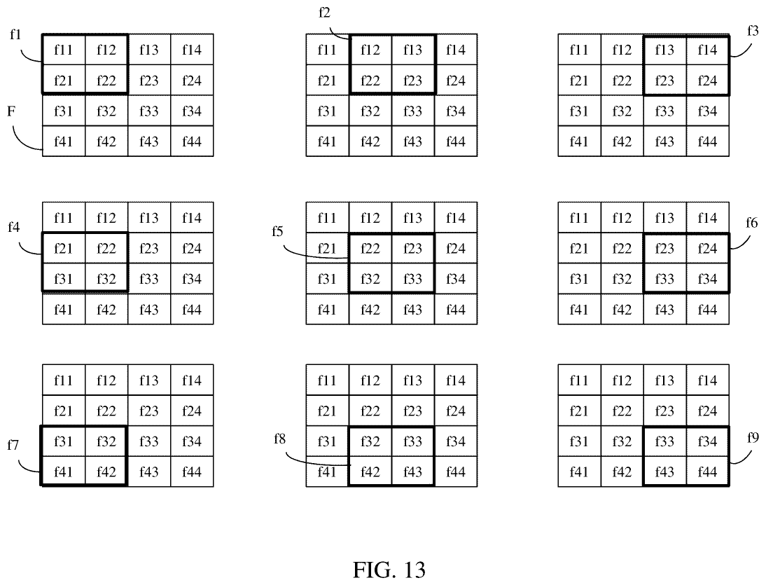

In addition, the machine learning model is a convolutional neural network (CNN) that has a stride of one. Therefore, the machine learning model has nine 2×2 inputs f1 to f9 as shown in FIG. 13. The memory circuits 200, 300, and 400 of the system 10 perform the matrix multiplications (or MAC computations) between the weights W1 and W2 and the inputs f1 to f9 to generate the outputs O1 and O2.

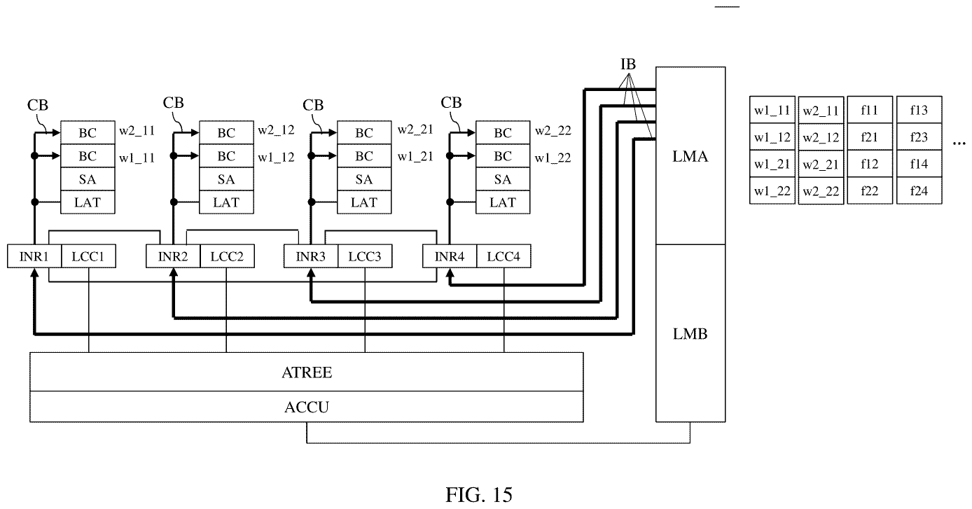

FIGS. 15-19 depict steps of the operation of the memory circuit 500 to perform MAC computations of the inputs f1 to f9 and the weights W1 to W2.

As shown in FIGS. 15-19, compared with the memory circuit 300 of FIG. 2, the memory circuit 500 includes four columns of bit cells BC. The input registers INR and the local computing cells LCC corresponding to the four columns are annotated as input registers INR1 to INR4 and local computing cells LCC1 to LCC4.

As shown in FIG. 15, in a first step, elements of the weights W1 to W2 and the inputs f1 to f9 are streamed to the local memory LMA and stored in the local memory LMA.

Then, the elements w1_11, w1_12, w1_21 and w1_22 of the weight W1 are simultaneously transmitted from the local memory LMA to the input registers INR1 to INR4 through input bus IB of the memory circuit 500. The elements w1_11, w1_12, w1_21 and w1_22 are transmitted from input registers INR1 to INR4 to the first row of bit cells BC through cell bus CB.

Similarly, the elements w2_11, w2_12, w2_21 and w2_22 of the weight W2 are transmitted from the local memory LMA to the input registers INR1 to INR4 through input bus IB of the memory circuit 500. The elements w2_11, w2_12, w2_21 and w2_22 are transmitted from input registers INR1 to INR4 to the second row of bit cells BC through cell bus CB.

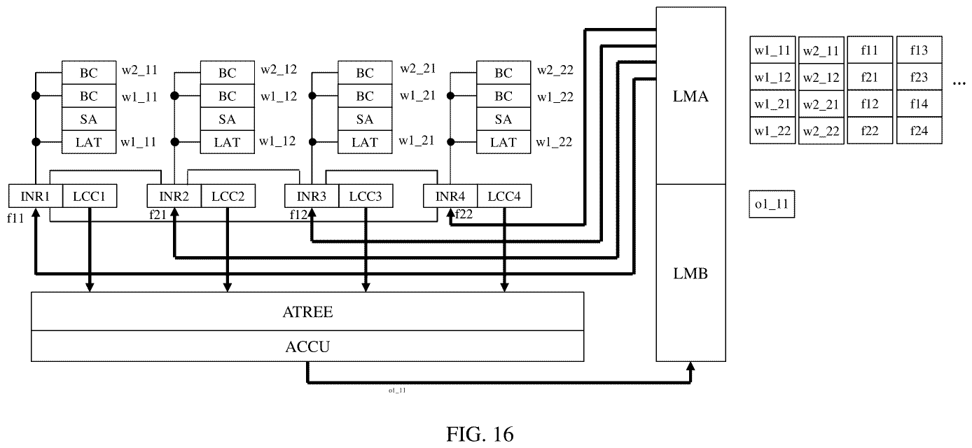

As shown in FIG. 16, in a second step, the elements f11, f12, f21 and f22 of the input f1 are transmitted from the local memory LMA to the input registers INR1 to INR4 through the input bus IB.

The sense amplifiers SA read the elements w1_11, w1_12, w1_21 and w1_22 of the weight W1 from the first row of bit cells BC. The latches LAT store the elements w1_11, w1_12, w1_21 and w1_22 received from the sense amplifiers SA.

The local computing cells LCC1 to LCC4 perform computations (e.g., multiplications) between the elements w1_11, w1_12, w1_21, w1_22 and the elements f11, f12, f21, f22 to generate computation results to the adder tree ATREE. For example, the local computing cell LCC1 performs the multiplication between the element f11 and the element w1_11 to generate a computation result to the adder tree ATREE.

The adder tree ATREE sums up the results from the local computing cells LCC1 to LCC4. The accumulator ACCU accumulates the sum from the adder tree ATREE and generate the element o1_11 of the output O1. The element o1_11 corresponds to the MAC computations of the weight W1 and the input f1. The local memory LMB stores the element o1_11.

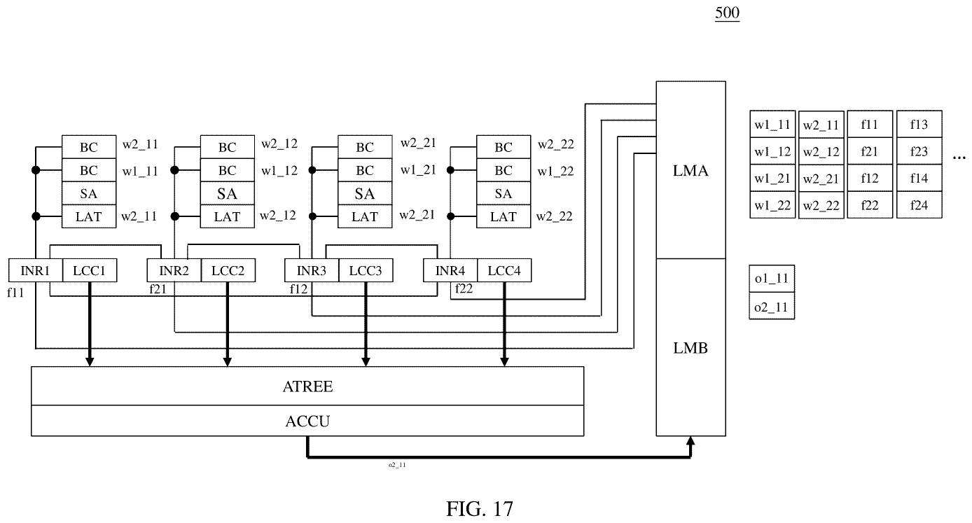

As shown in FIG. 17, in a third step, the sense amplifiers SA read the elements w2_11, w2_12, w2_21 and w2_22 of the weight W2 from the second row of bit cells BC. The latches LAT store the elements w2_11, w2_12, w2_21 and w2_22 received from the sense amplifiers SA.

In the third step, the data flow for the computation of the memory circuit 500 is input-stationary. Specifically, the inputs for computation of the local computing cells LCC1 to LCC4 in the second and third steps are maintained the same. The local computing cells LCC1 to LCC4 perform computations (e.g., multiplications) between the elements w2_11, w2_12, w2_21, w2_22 and the elements f11, f12, f21, f22 to generate computation results to the adder tree ATREE. For example, the local computing cell LCC1 performs the multiplication between the element f11 and the element w2_11 to generate a computation result to the adder tree ATREE.

The adder tree ATREE sums up the results from the local computing cells LCC1 to LCC4. The accumulator ACCU accumulates the sum from the adder tree ATREE and generate the element o2_11 of the output O2. The element o2_11 corresponds to the MAC computations of the weight W2 and the input f1. The local memory LMB stores the element o2_11.

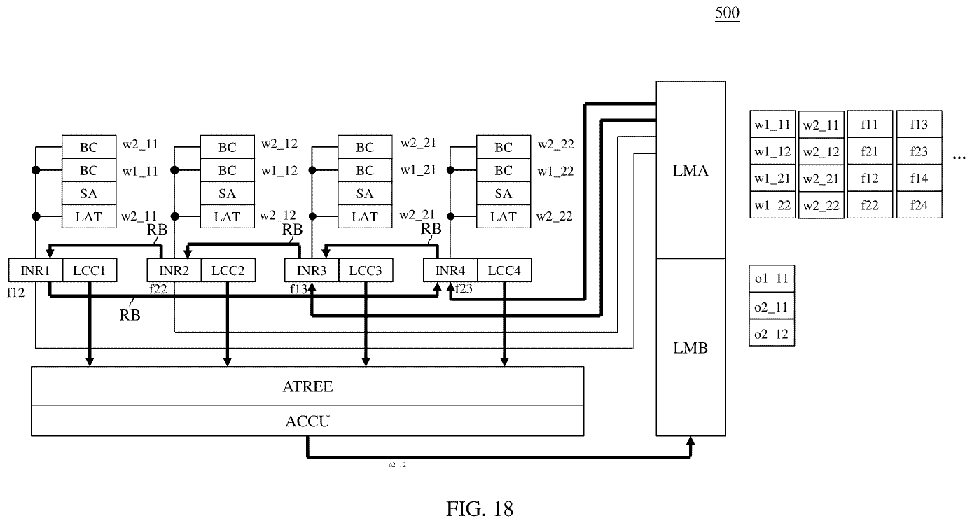

As shown in FIG. 18, in a fourth step, the data in the input registers INR1-INR4 is updated as the input f2. As shown in FIG. 13, in the inputs f1 and f2, the elements f12 and f22 are repeated. In other words, the elements f12 and f22 are included in both the inputs f1 and f2. Therefore, since the input registers INR store the input f1 before the fourth step, the elements f12 and f22 are already stored in the input registers INR before the updating the data stored in the input registers INR.

In order to reuse the repeated elements, a register ring bus transmission is performed. In one register ring bus transmission, the data in each input register INR is transmitted to the next input register INR in a register ring bus RB. For example, the data in the input register INR4 is transmitted to the input register INR3. The data in the input register INR3 is transmitted to the input register INR2. The data in the input register INR2 is transmitted to the input register INR1. The data in the input register INR1 is transmitted to the input register INR4.

Specifically, in the register ring bus transmission, the control circuit 100 pulls the rotate signal R to have the first logic value (e.g., logic one) to make the multiplexer MUX in the input register INR to select the output of the adjacent input register INR as the output of the multiplexer MUX as described in the paragraphs corresponding to FIG. 10.

In the fourth step, the register ring bus transmission is performed twice. After two register ring bus transmission, the input register INR1 stores the element f12, the input register INR2 stores the element f22, etc.

Then, the local memory LMA outputs the elements f13 and f23 to the input registers INR3 and INR4 respectively to partially update the input registers INR.

In some embodiments, when the local memory LMA outputs the elements f13 and f23 to the input registers INR3 and INR4, the control circuit 100 pulls the enable signals EN1 and EN2 of the input registers INR1 and INR2 to have the second logic value (e.g., logic one) to disable the input registers INR1 and INR2 from updating the data stored in the input registers INR1 and INR2.

In the fourth step, the data flow for the computation of the memory circuit 500 is weight-stationary. Specifically, in order to reuse the weight stored in the latches LAT, the weights for computation of the local computing cells LCC1 to LCC4 in the third and fourth steps are maintained the same. The local computing cells performs computations (e.g., multiplications) between the elements w2_11, w2_12, w2_21, w2_22 and the elements f12, f22, f13, f23 to generate computation results to the adder tree ATREE. For example, the local computing cell LCC1 performs the multiplication between the element f12 and the element w2_11 to generate a computation result to the adder tree ATREE.

The adder tree ATREE sums up the results from the local computing cells LCC1 to LCC4. The accumulator ACCU accumulates the sum from the adder tree ATREE and generate the element o2_12 of the output O2. The element o2_12 corresponds to the MAC computations of the weight W2 and the input f2. The local memory LMB stores the element o2_12.

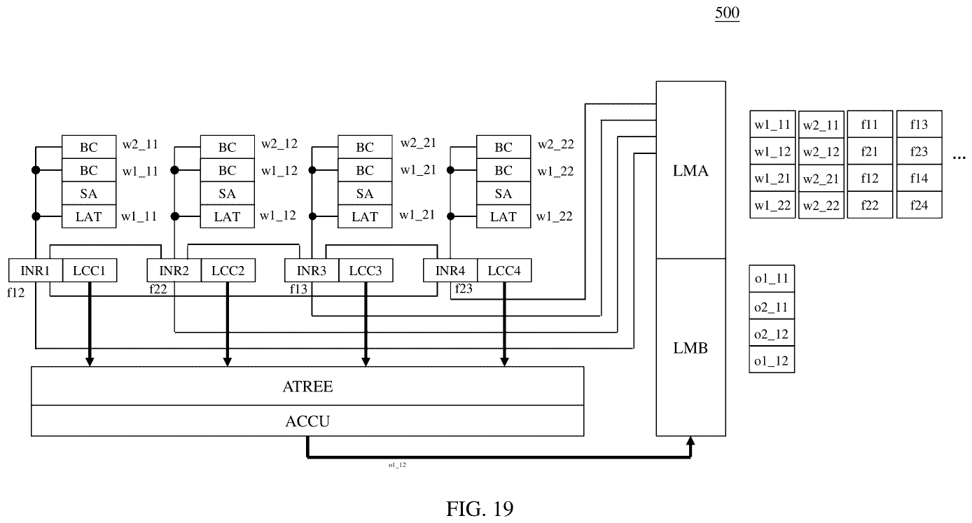

As shown in FIG. 19, in a fifth step, the sense amplifiers SA read the elements w1_11, w1_12, w1_21 and w1_22 of the weight W1 from the first row of bit cells BC. The latches LAT store the elements w1_11, w1_12, w1_21 and w1_22 received from the sense amplifiers SA.

In the fifth step, the data flow for the computation of the memory circuit 500 is input-stationary. Specifically, the inputs for computation of the local computing cells LCC1 to LCC4 in the fourth and fifth steps are maintained the same. The local computing cells performs computations (e.g., multiplications) between the elements w1_11, w1_12, w1_21, w1_22 and the elements f12, f22, f13, f23 to generate computation results to the adder tree ATREE. For example, the local computing cell LCC1 performs the multiplication between the element f12 and the element w1_11 to generate a computation result to the adder tree ATREE.

The adder tree ATREE sums up the results from the local computing cells LCC1 to LCC4. The accumulator ACCU accumulates the sum from the adder tree ATREE and generate the element o1_12 of the output O1. The element o1_12 corresponds to the MAC computations of the weight W1 and the input f2. The local memory LMB stores the element o1_12.

Then, the memory circuit 500 operates in a similar manner with respect to the described second to fifth steps to generate each element of the outputs O1 and O2.

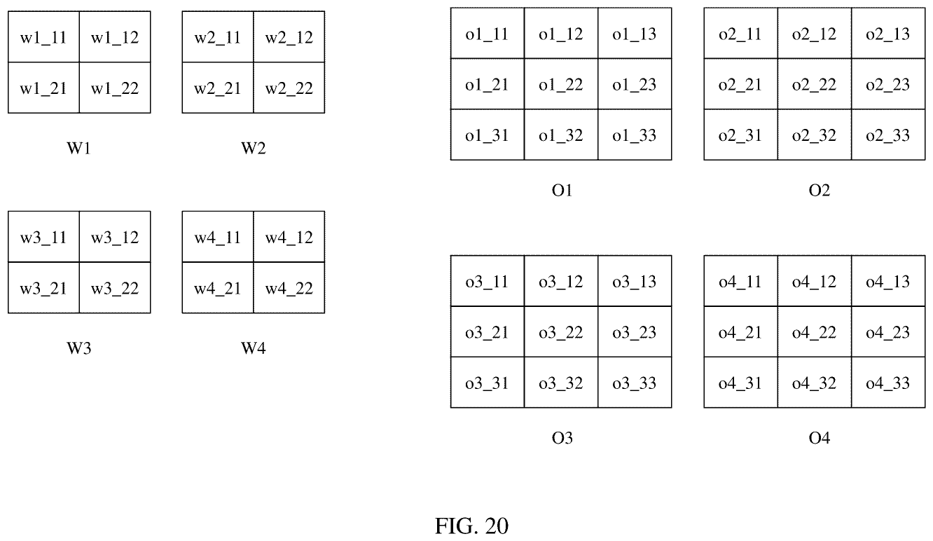

Reference is now made to FIGS. 20-22. FIGS. 20-22 depict an example of operation of a memory circuit 600 configured with respect to the memory circuits 200, 300, 400 and 500 of FIGS. 1-19, in accordance with various embodiments of the present disclosure. With respect to the embodiments of FIGS. 1-19, like elements in FIGS. 20-22 are designated with the same reference numbers for ease of understanding.

Compared with the machine learning model in the example of FIGS. 12-14, the machine learning model in the example of FIGS. 20-22 has four weights (kernels) W1-W4. Accordingly, the memory circuit 600 generates four outputs O1-O4 of the machine learning model as shown in FIG. 20.

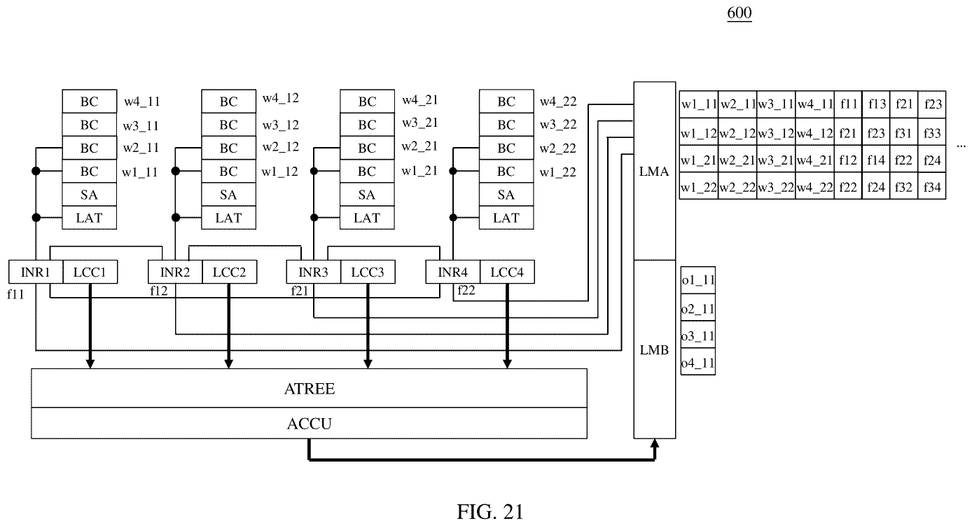

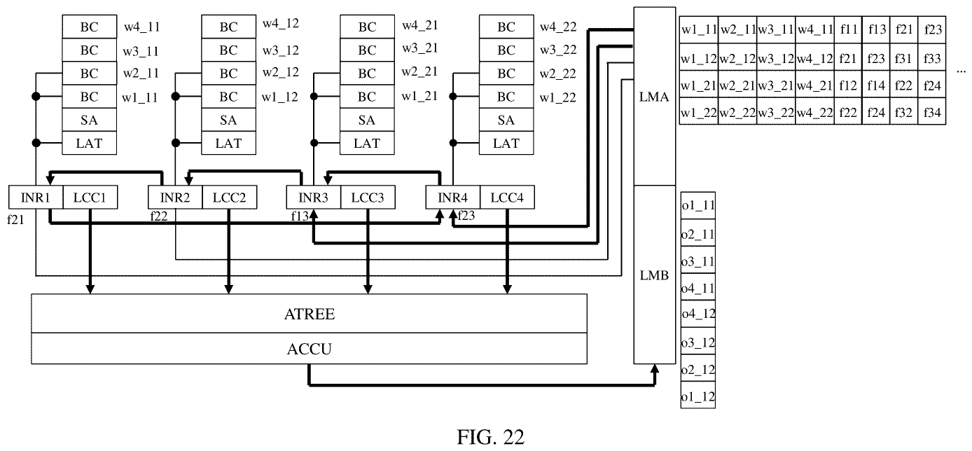

Compared with the memory circuit 500 in the example of FIGS. 12-14, the memory circuit 600 in the example of FIGS. 20-22 includes four rows of bit cells BC to store the weights W1-W4 as shown in FIGS. 21-22.

As shown in FIG. 21, in a first step of the operation of the memory circuit 600 to compute the outputs O1-O4, the local memory LMA outputs the weights W1 to W4 to the input registers INR1-INR4. Then, the first to fourth rows of the bit cells BC store the weights W1 to W4 respectively.

In a second step of the operation of the memory circuit 600 to compute the outputs O1-O4, the local memory LMA outputs elements f11, f12, f21 and f22 of the input f1 to the input registers INR1-INR4 respectively.

Then, the local computing cells LCC1 to LCC4 perform computations (e.g., multiplications) between the elements w1_11, w1_12, w1_21, w1_22 and the elements f11, f12, f21, f22 to generate computation results to the adder tree ATREE. The adder tree ATREE sums up the results from the local computing cells LCC1 to LCC4. The accumulator ACCU accumulates the sum from the adder tree ATREE and generates the element o1_11 of the output O1. The element o1_11 corresponds to the MAC computations of the weight W1 and the input f1. The local memory LMB stores the element o1_11. In the following third to fifth steps, the memory circuit 600 generates the elements o2_11 to o4_11 in a similar manner.

In the third to fifth steps, the data flow for the computation of the memory circuit 600 is input-stationary. Specifically, the inputs for computation of the local computing cells LCC1 to LCC4 in the second to fifth steps are maintained the same. In other words, the inputs for the computation of the local computing cells LCC1 to LCC4 are unchanged for three steps.

In the third to fifth steps, the local computing cells LCC1 to LCC4 perform computations between the input f1 and the weights W2 to W4 to generate the elements o2_11 to o4_11 sequentially.

As shown in FIG. 22, in a sixth step of the operation of the memory circuit 600 to compute the outputs O1-O4, the input in the input registers INR1 to INR4 are updated with two elements reused in a similar manner as described in the paragraphs with reference to FIG. 18.

Specifically, the register ring bus transmission is performed twice to transmit the elements f21, f22 in the input registers INR3, INR4 to the input registers INR1, INR2 for reusing the elements f21, f22. Then, the input registers INR3, INR4 are partially updated to store the elements f13, f23.

Then, in the following seventh to tenth steps, the memory circuit 600 generates elements o4_12, o3_12, o2_12 and o1_12 respectively.

In the seventh step, the weight W4 is reused. Specifically, the elements w4_11 to w4_22 are maintained in the latches LAT in the seventh step. Therefore, the weight elements for computation of the local computing cells LCC1 to LCC4 in the fifth and seventh steps are maintained the same. In other words, in the seventh step, the data flow for the computation of the memory circuit 600 is weight-stationary. After the computation of the local computing cells LCC1 to LCC2, the adder tree ATREE and the accumulator ACCU generate the element o4_12.

In the eighth to tenth steps, the memory circuit 600 generates the elements o3_12, o2_12 and o1_12 respectively. In the eighth to tenth steps, the data flow for the computation of the memory circuit 600 is input-stationary. Specifically, the input elements for computation of the local computing cells LCC1 to LCC4 in the eighth to tenth steps are maintained the same. The local computing cells LCC1 to LCC4 perform computations (e.g., multiplications) between the input f2 and the weights W3 to W1 in the eighth to tenth steps. Different from the second to fifth steps, in the seventh to tenth steps, the computation order of the weights is from the weight W4 to W1.

The following Table 1 shows the input stored the input registers INR1-INR4, weight stored in the latches LAT, dataflow, output element in each step.

TABLE 1

| step | input | weight | dataflow | Output element |
|---|---|---|---|---|
| 2 | f1 | W1 | | o1_11 |
| 3 | f1 | W2 | input-stationary | o2_11 |
| 4 | f1 | W3 | input-stationary | o3_11 |
| 5 | f1 | W4 | input-stationary | o4_11 |
| 6 | f2 | W4 | weight-stationary | o4_12 |
| 7 | f2 | W3 | input-stationary | o3_12 |
| 8 | f2 | W2 | input-stationary | o2_12 |
| 9 | f2 | W1 | input-stationary | o1_12 |
| 10 | f3 | W1 | weight-stationary | o1_13 |
| 11 | f3 | W2 | input-stationary | o2_13 |
| 12 | f3 | W3 | input-stationary | o3_13 |
| 13 | f3 | W4 | input-stationary | o4_13 |

As shown in Table 1, the weight access of the latches LAT from the bit cells BC is in a meandering style. Specifically, in order to reuse the weight already stored in the latches LAT, when updating input in the input register INR, the weight (e.g., W4 in step 6) in the latches LAT are kept the same and the local computing cell LCC performs computation in the weight-stationary manner. Accordingly, the order of the weights accessed corresponding to a first input (e.g., f1) and that of a second input (e.g., f2) are inverted (e.g., W1 to W4 and W4 to W1) for the sake of continuity.

As shown in Table 1, when computation between one input and all weights are finished, the dataflow is switched from input-stationary to weight-stationary. As a result, in some embodiments, the computations of the system 10 repeats in a manner of “k−1” input-stationary computations following by one weight-stationary computation, in which k is the number of the weights, for example, four. The computations of the inputs f4-f9 are performed in the similar manner as described above.

The configurations of FIGS. 12-22 are given for illustrative purposes. Various implements are within the contemplated scope of the present disclosure. For example, in some embodiments, the size of the weights is larger than 2×2 and the number of columns of the bit cells BC are more than four.

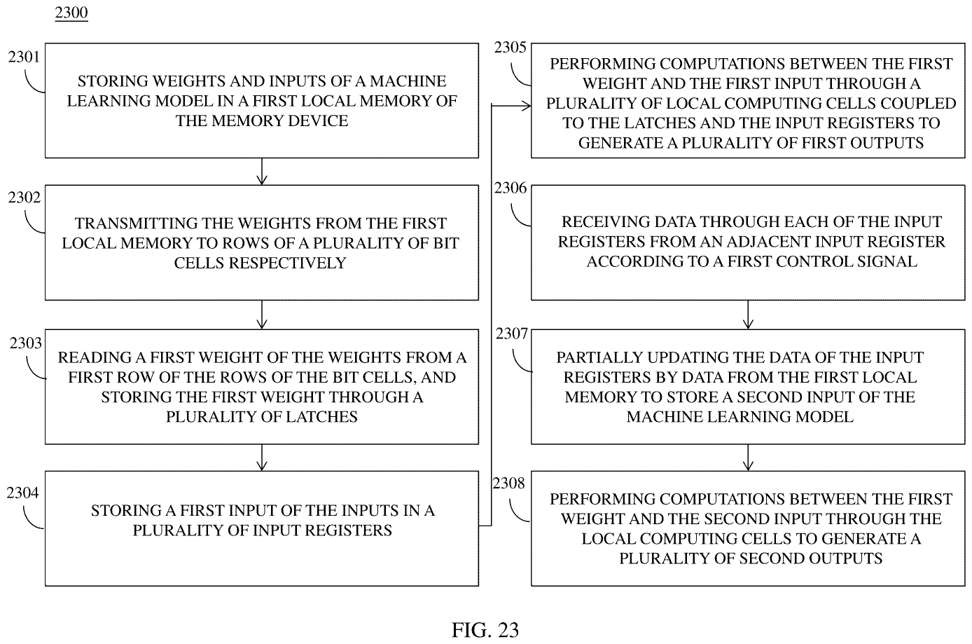

Reference is now made to FIG. 23. FIG. 23 is a flowchart diagram of a method 2300 for operating the system 10, the control circuit 100, the memory circuits 200, 300, 400, 500 or 600 as shown in FIGS. 1-22, in accordance with some embodiments of the present disclosure. It is understood that additional operations can be provided before, during, and after the operations shown by FIG. 23, and some of the operations described below can be replaced or eliminated, for additional embodiments of the method. The order of the operations may be interchangeable. Throughout the various views and illustrative embodiments, like reference numbers are used to designate like elements. The method 2300 includes operations 2301-2308 that are described below with reference to the system 10, the control circuit 100, the memory circuits 200, 300, 400, 500 and 600 as shown in FIGS. 1-22.

With the method 2300, the control circuit 100 instructs the memory circuits 200, 300, 400, 500 and 600 to perform the machine learning model computations in the input-stationary manner or the weight-stationary manner, and to generate outputs of the machine learning model. In some embodiments, the control circuit 100 instructs the memory circuits 200, 300, 400, 500 and 600 to perform the operations 2301-2308.

In operation 2301, the control circuit 100 writes the weights and inputs of the machine learning model in the local memory LMA. For example, as shown in FIG. 15, the control circuit 100 concatenates each row of elements of the weight W1 and writes the concatenation of the rows in a column of the local memory LMA. Specifically, the local memory LMA stores the elements w1_11, w1_12, w1_21 and w1_22 sequentially in the column of the local memory LMA.

In some embodiments, the control circuit 100 concatenates each column of elements of a first input (e.g., f1) and writes the concatenation of the columns of the elements in a first column of the local memory LMA. For example, the local memory LMA stores the elements f11, f21, f12 and f22 sequentially in the first column of the local memory LMA.

In some embodiments, the control circuit 100 determines whether a first portion of a second input (e.g., f2) is included in a previous input (e.g., f1). When the first portion (e.g., f12, f22) is determined in the previous input, the control circuit 100 writes a second portion (e.g., f13, f23) of the second input in a column or rows that are adjacent to where the local memory LMA store the previous input without writing the first portion.

In operation 2302, the weights are transmitted from the local memory LMA to rows of bit cells BC respectively. For example, as shown in FIG. 15, the local memory LMA outputs the weights W1 and W2 to the input registers INR1-INR4 through the input bus IB. The input registers INR1-INR4 output the weights W1 and W2 to the bit cells BC through the cell bus CB. Each row of bit cells BC stores a weight. Specifically, the first row of bit cells BC store the elements w1_11, w1_12, w1_21 and w1_22.

In operation 2303, the sense amplifiers SA read one of the weights from a row of the bit cells BC, and the latches LAT stores the weight read by the sense amplifiers SA. For example, as shown in FIG. 16, the sense amplifiers SA in the first to fourth columns read the elements w1_11, w1_12, w1_21 and w1_22 respectively from the first row of the bit cells BC. Then, the latches LAT in the first to fourth columns store the elements w1_11, w1_12, w1_21 and w1_22 respectively from the sense amplifiers SA.

In operation 2304, the input registers INR store one of the inputs of the machine learning model from the local memory LMA. For example, as shown in FIG. 16, the local memory LMA outputs the elements f11, f21, f12, f22 of the input f1 to the input registers INR1-INR4 respectively. Then, the input registers INR1-INR4 store the elements f11, f21, f12, f22.

In operation 2305, the local computing cells LCC perform computations between the weight stored in the latches LAT and the input stored in the input registers INR to generate an element of the output of the machine learning model. For example, as shown in FIG. 16, the local computing cells LCC1-LCC4 perform multiplications between the elements w1_11, w1_12, w1_21 and w1_22 the elements f11, f21, f12, f22 and generate multiplication results for computing the element o1_11.

In operation 2306, each input register INR receive data from an adjacent input register INR according to the rotate signal R. Specifically, each input register INR in the register ring bus RB transmits the data it store to a next input register INR in the register ring bus RB. For example, as shown in FIG. 18, in the register ring bus transmission, the input register INR2 outputs the data it store to the next input register INR1, the input register INR1 outputs the data it store to the input register INR4.

In some embodiments, the control circuit 100 pulls up the rotate signal R to start the register ring bus transmission. Specifically, as shown in FIG. 10, the multiplexer MUX in each input registers INR transmits data from the adjacent input register INR to the D flip-flop DFF in response to the rotate signal R pulled high.

The control circuit 100 pulls down the rotate signal R to stop the register ring bus transmission. Specifically, as shown in FIG. 10, the multiplexer MUX in each input registers INR transmits data from the local memory LMA to the D flip-flop DFF in response to the rotate signal R pulled down.

In operation 2307, the memory circuits 200, 300, 400, 500 and 600 partially update the data stored in the input registers INR by data from the local memory LMA to store an input of the machine learning model. For example, as shown in FIG. 18, among the four input registers INR1-INR4, two input registers INR3-INR4 are updated to store the elements f13, f23 from the local memory LMA. After the update, the input registers INR1-INR4 store the elements f12, f22, f13, f23 of the input f2.

In some embodiments, to partially update the input registers INR, the control circuit 100 pulls up the enable signal (e.g., EN1-EN2) to the tri-state buffer 1101 corresponding to a first group (e.g., INR1-INR2 in FIG. 18) of the input registers INR to stop transmitting data from the local memory LMA to the first group of the input registers INR. On the contrary, the control circuit 100 pulls down the enable signal (e.g., EN1-EN2) to the tri-state buffer 1101 corresponding to a second group (e.g., INR3-INR4 in FIG. 18) of the input registers INR to transmit data from the local memory LMA to the second group of the input registers INR.

In operation 2308, after the update of operation 2307, the local computing cells LCC perform computations between the weight stored in the latches LAT and the updated input of the input registers INR to generate an element of the output of the machine learning model in a weight-stationary manner. For example, as shown in FIG. 18, the local computing cells LCC1-LCC4 perform multiplications between the elements w2_11, w2_12, w2_21 and w2_22 the elements f12, f22, f13, f23 and generate multiplication results for computing the element o2_12.

In some embodiments, the control circuit 100 instructs the memory circuits 200, 300, 400, 500 and 600 to perform computations in an input-stationary manner. Specifically, the local computing cells LCC perform computations between weight and input with the input fixed and the weight updated continuously. For example, as shown in FIG. 17, the weight W1 stored in the latches LAT are updated by the weight W2. The input registers INR1-INR4 keep storing the input f1. The local computing cells LCC1-LCC4 perform multiplication between the fixed input f1 and the updated weight W2 after multiplication between the fixed input f1 and the weight W1.

In some embodiments, when the input-stationary computations of the fixed input and all weights of the machine learning model are finished, the memory circuits 200, 300, 400, 500 and 600 update the data stored in the input registers INR by a second input of the machine learning model, and the latches LAT continue storing the weight already in the latches LAT. Then, the local computing cells LCC perform computations between the second input and the weight in the latches LAT in a weight-stationary manner.

For example, as shown in FIG. 22, the memory circuit 600 performs the computations between the input f1 and the weights W1-W4 in the input-stationary manner. Then, the memory circuit 600 updates the input f1 in the input registers INR1-INR4 by the input f2 and performs the computation between the input f2 and the weight W4 in the weight-stationary manner. Then, the computation between the input f2 and the weight W3-W1 is in the input-stationary manner.

In some embodiments, the data access of the bit cells BC to the latches LAT is in a meandering style. For example, as shown in FIG. 21, in the input-stationary computations of the input f1 and the weights W1-W4, the order of the latches LAT accessing the bit cells BC is from the first row to the fourth row to store the weights W1-W4 sequentially. Then, after the input-stationary computations of the input f1 and the weights W1-W4 are finished, the input f1 is updated by the input f2. The memory circuit 600 starts to perform the computations between the input f2 and the weights W1-W4. As shown in FIG. 22, compared with the computations of the input f1 and the weights W1-W4, in the computations of the input f2 and the weights W1-W4, the order of the latches LAT accessing the bit cells BC is inverted, which is from the fourth row to the first row to store the weights W4-W1 sequentially. As a result, the order of the computations corresponding to the weights W1-W4 is also inverted.

As described above, the present disclosure provides an AI acceleration system, memory device and a method to operate the system and the memory device. The system and memory device enable input-stationary and weight-stationary dataflow. According to instructions from a control circuit, the dataflow of the memory device can be switched between the input-stationary manner and the weight-stationary manner. The energy consumption of the provided interleaving input-stationary and weight-stationary system is about 12.6% lower than some approaches of a input-stationary system, and about 20.1% lower than some approaches of a weight-stationary system.

In some embodiments, a system for artificial intelligence acceleration is provided. The system includes a control circuit and a memory circuit coupled to the control circuit. The memory circuit includes a first local memory and a computing circuit. The first local memory stores weights and inputs of a machine learning model. The computing circuit includes input registers and local computing cells. The input registers are coupled together as a ring bus. Each of the input registers selects between first data from the first local memory and second data from an adjacent input register in the ring bus according to a first control signal from the control circuit. Each of the input registers stores the selected one of the first and second data. The local computing cells perform computations between data stored in the input registers and the weights.

In some embodiments, a memory device is provided. The memory device includes a first local memory and a computing circuit. The first local memory stores weights and inputs of a machine learning model. The computing circuit includes: a first column of bit cells to a fourth column of bit cells that store the weights from the first local memory; a first latch to a fourth latch that are coupled to the first to fourth columns respectively, in which the first to fourth latches store data read from the first to fourth columns of bit cells; a first input register to a fourth input register that are coupled to the first to fourth columns respectively and coupled to the first local memory, in which each of the first to fourth input registers store first data from the first local memory or second data from an adjacent input register according to a first control signal; and a first local computing cell to a fourth local computing cell that perform computations between data in the first to fourth latches and data in the first to fourth input registers respectively to generate first to fourth results, in which the computing circuit generates an output according to a sum of the first to fourth results.

In some embodiments, a method for operating a memory device is provided. The method includes: storing weights and inputs of a machine learning model in a first local memory of the memory device; transmitting the weights from the first local memory to rows of a plurality of bit cells respectively; reading a first weight of the weights from a first row of the rows of the bit cells, and storing the first weight through a plurality of latches; storing a first input of the inputs in a plurality of input registers; performing computations between the first weight and the first input through a plurality of local computing cells coupled to the latches and the input registers to generate a plurality of first outputs; receiving data through each of the input registers from an adjacent input register according to a first control signal; partially updating the data of the input registers by data from the first local memory to store a second input of the machine learning model; and performing computations between the first weight and the second input through the local computing cells to generate a plurality of second outputs.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a control circuit; and
a memory circuit coupled to the control circuit and comprising:
a first local memory configured to store a plurality of weights and a plurality of inputs; and
a computing circuit comprising:
a plurality of input registers coupled together to configured as a ring bus, wherein each of the input registers is configured to select between first data from the first local memory and second data from an adjacent input register in the ring bus according to a first control signal from the control circuit,
wherein each of the input registers is further configured to store the selected one of the first and second data; and
a plurality of local computing cells configured to perform computations between data stored in the input registers and the weights to generate computation results.

2. The system of claim 1, wherein the computing circuit further comprises:
an adder tree coupled to the local computing cells, wherein the adder tree is configured to sum up the computation results of the local computing cells; and
an accumulator coupled to the adder tree, wherein the accumulator is configured to accumulate sums generated by the adder tree to generate a multiply-and-accumulate result of one of the weights and one of the inputs.

3. The system of claim 1, wherein the computing circuit further comprises:
a plurality of bit cells arranged in rows and columns, wherein each bit cells in each of the columns is coupled to a corresponding input register of the input registers,
wherein each row of the bit cells is configured to store one of the weights transmitted from the input registers.

4. The system of claim 3, wherein the computing circuit further comprises:
a plurality of latches, wherein each of the latches is coupled to a corresponding column of the columns of the bit cells and is configured stored data from a selected bit cell in the corresponding column,
wherein the local computing cells are further configured to receive the weights from the latches for the computations between the data stored in the input registers and the weights.

5. The system of claim 4, wherein the latches are further configured to receive the weights from the rows of the bit cells one after another for the local computing cells to perform first computations between the weights and a first input of the inputs in an input stationary manner,
wherein the input registers are further configured to store a second input of the inputs after the first computations, and the local computing cells perform a second computations of the second input in a weight stationary manner.

6. The system of claim 4, wherein the latches are further configured to receive the weights from the rows of the bit cells in a first order for the local computing cells to perform first computations between the weights and a first input of the inputs, and
the latches are further configured to receive the weights from the rows of the bit cells in a second order inverted to the first order for the local computing cells to perform second computations between the weights and a second input of the inputs.

7. The system of claim 1, wherein each of the input register comprises:
a multiplexer having a first input terminal and a second input terminal, wherein the first input terminal is coupled to an adjacent input register in the ring bus, and the second input terminal is coupled to the first local memory,
wherein the multiplexer is configured to output data from the input terminal or data from the second input terminal according to the first control signal; and
a flip-flop configured to store the output from the multiplexer, wherein the flip-flop is further configured to output data to a corresponding local computing cell of the local computing cells for the computations.

8. The system of claim 7, wherein each of the input registers further comprises:
a tri-state buffer coupled between the first local memory and the multiplexer, wherein the tri-state buffer stops transmitting the first data to the multiplexer according to a second control signal from the control circuit.

9. The system of claim 8, wherein the control circuit is configured to pull up the second control signal of each input register of a first group of the input registers, and pull down the second control signal of each input register of a second group of the input registers to partially update the data stored in the first group of the input registers.

10. A memory device, comprising:
a first local memory configured to store weights and inputs; and
a computing circuit comprising:
a first column of bit cells to a fourth column of bit cells that are configured to store the weights transmitted from the first local memory;
a first latch to a fourth latch that are coupled to the first to fourth columns respectively, wherein the first to fourth latches are configured to store data read from the first to fourth columns of bit cells;
a first input register to a fourth input register that are coupled to the first to fourth columns respectively and coupled to the first local memory,
wherein each of the first to fourth input registers is configured to store first data from the first local memory or second data from an adjacent input register according to a first control signal; and
a first local computing cell to a fourth local computing cell configured to perform computations between data in the first to fourth latches and data in the first to fourth input registers respectively to generate first to fourth results,
wherein the computing circuit is configured to generate an output according to a sum of the first to fourth results.

11. The memory device of claim 10, wherein the first to fourth input registers are coupled as a input register chain sequentially,
wherein each of the first to fourth input registers comprises a multiplexer coupled to a previous input register in the input register chain, wherein each of the first to third input registers is configured to output the second data to the multiplexer of a next input register in the input register chain according to the first control signal,
wherein the fourth input register at the end of the input register chain is configured to output the second data to the multiplexer of the first input register according to the first control signal.

12. The memory device of claim 10, wherein each of the first to fourth input registers comprises:
a flip-flop configured to output the data stored in the flip-flop to a corresponding local computing cell of the local computing cells; and
an AND gate that has a first input terminal coupled to a clock signal and has an output terminal of the AND gate is coupled to the flip-flop.

13. The memory device of claim 12, wherein the flip-flop is further configured to update the data stored in the flip-flop according to the clock signal,
wherein the AND gate further has a second input terminal configured to receive a second control signal,
wherein the AND gate is configured to stop transmitting the clock signal to the flip-flop to disable the updating of the flip-flop in response to the second control signal.

14. A method for operating a memory device, comprising:
storing weights and inputs in a first local memory of the memory device;
transmitting the weights from the first local memory to rows of a plurality of bit cells respectively;
reading a first weight of the weights from a first row of the rows of the bit cells, and storing the first weight through a plurality of latches;
storing a first input of the inputs in a plurality of input registers;
performing computations between the first weight and the first input through a plurality of local computing cells coupled to the latches and the input registers to generate a plurality of first outputs;
receiving data through each of the input registers from an adjacent input register according to a first control signal;
partially updating the data of the input registers by data from the first local memory to store a second input of a machine learning model; and
performing computations between the first weight and the second input through the local computing cells to generate a plurality of second outputs.

15. The method of claim 14, further comprising:
updating data stored in the latches by a second weight of the weights; and
continuing storing the second input in the input registers and performing computations between the second weight and the second input through the local computing cells in an input-stationary manner.

16. The method of claim 14, further comprising:
when computations between the second input and all of the weights are finished, updating the data stored in the input registers by a third input of the machine learning model, and continuing storing a second weight in the latches and performing computations between the third input and the second weight through the local computing cells in an weight-stationary manner.

17. The method of claim 16, further comprising:
transmitting the weights to the latches in a first order during the computations between the weights and the second input; and
transmitting the weights to the latches in a second order inverted to the first order during the computations between the weights and the third input.

18. The method of claim 15, wherein partially updating the data comprises:
pulling up a second control signal to a tri-state buffer in a first group of the input registers to stop transmitting data from the first local memory to the first group of the input registers; and
transmitting the data from the first local memory to a second group of the input registers.

19. The method of claim 15, further comprises:
pulling up the first control signal to control a multiplexer in each of the input registers to transmit data from the adjacent input register;
pulling down the first control signal to control the multiplexer in each of the input registers to transmit data from the first local memory; and
storing the data transmitted from the multiplexer in a flip-flop of each of the input registers.

20. The method of claim 15, wherein storing the weights and the inputs in the first local memory comprises:
storing the first input in a first column of the first local memory;
determining whether a first portion of a second input of the inputs is included in the first input; and
when the first portion is determined in the first input, storing a second portion of the second input in a second column adjacent to the first column in the first local memory without storing the first portion.
